(19) United States
(12) Patent Application Publication
(10) Pub. No.: US 2009/0041415 A1
(43) Pub. Date: Feb. 12, 2009

(54) DOUBLE-CORE OPTICAL FIBER

(75) Inventors: Hiromasa Tanobe, Kanagawa-ken (JP); Yoshihisa Sakai, Kanagawa-ken (JP)

Correspondence Address: Workman Nydegger;1000 Eagle Gate Tower, 60 East South Temple, Salt Lake City, UT, 84111, US

(73) Assignee: Nippon Telegraph and Telephone Corporation, Tokyo (JP)

(21) Appl. No.: 12/281,469

(22) PCT Filed: Mar. 23, 2007
(86) PCT No.: PCT/JP2007/056099

§ 371 Date: Sep. 2, 2008

(30) Foreign Application Priority Data
Apr. 5, 2006 (JP) 2006-104535

(51) Int. Cl. G02B 6/036

(52) U.S. Cl. 385/127

(57) ABSTRACT

A double core optical fiber is provided, in which single mode signal light and multimode signal light can be transmitted and a multimode transmission of the signal light guided through the core can be reduced even when the optical fiber is bent. The double core optical fiber of the present invention includes a core (111) arranged on a central axis of the optical fiber and having a refractive index (112), a first cladding (121) arranged on the outer circumference of the core (111) and having a refractive index (122) smaller than the refractive index (112), and a second cladding arranged on the outer circumference of the first cladding (121) and having a refractive index (132) smaller than the refractive index (122). The core (111) functions as a core for single mode transmission, the core (111) and the first cladding (121) function as a core for multimode transmission, the first cladding (121) function as a cladding for the core for single mode transmission, and the second cladding (132) functions as a cladding for the core for multimode transmission.

### TECHNICAL FIELD

The present invention relates to a double core optical fiber, and more specifically relates to a double core optical fiber capable of transmitting a single mode (for example, long wavelength region single mode) optical signal and a multimode (for example, short wavelength region multimode) optical signal simultaneously.

### BACKGROUND ART

As known technology of propagating single mode propagating light and multimode propagating light having different wavelengths with the same optical fiber, there is a “double clad fiber.” A first cladding for simultaneously guiding output light from a pump laser is arranged outside a core doped with a rare earth element for amplifying signal light. The double clad fiber is structured with a second cladding arranged on the outer circumference of the first cladding, which is arranged on the outer circumference of the core. The output light from the pump laser couples with the first cladding, and propagates in multimode while intersecting with the core. When intersecting, the output light is absorbed by the rare earth element with which the core is doped, and thereby produces an effect of amplifying the signal light propagating through the core.

The refractive indices of the respective claddings are designed such that the refractive index of the first cladding is lower than the refractive index of the core, and that the refractive index of the second cladding is higher than the refractive index of the first cladding. The second cladding is made of a polymer resin and is designed to cover the first cladding. The use of the cover of the polymer resin enables us to absorb and remove scattered light generated in the process of amplifying the signal light. This basic approach is disclosed in Patent Document 1 with an object of removing a clad mode in a high refractive index optical fiber applied as a gain fiber of an optical fiber amplifier, and is already known technology.

Patent Document 1: Japanese Patent Laid-Open No. Hei 11-274613

### DISCLOSURE OF THE INVENTION

However, in the case where the basic structure of the “double clad fiber” is used as the transmission path of long wavelength region optical signals in single mode and short-wavelength-multimode region optical signals, a large number of portions having small bend radiuses are formed in the “double clad fiber” in some cases. In this case, the effective refractive index of the first cladding in the inner circumference direction (on an inner side of the bend) of the bended “double clad fiber” decreases and the effective refractive index of the first cladding in the outer circumference direction (on an outer side of the bend) contrarily increases simultaneously, whereby a region having an effective refractive index higher than the refractive index of the core may be formed on the outer circumference of the first cladding.

In this case, the guided long wavelength region single mode optical signal is emitted from the core to the first cladding and propagated in multimode in the first cladding simultaneously. When the “double clad fiber” returns from the bended state to a linear state, the signal light propagated in multimode in the first cladding couples with the core, interferes with the signal light originally guided through the core, and causes the bit error rate to increase. Further, known “double clad fibers” are each designed such that the first cladding has a high aperture ratio in order to couple optical output from the pump laser as much as possible. Thus, the double clad fibers provide favorable optical coupling with pump lasers, the optical coupling not requiring axis alignment and preferably having an aperture ratio as high as possible. The double clad fibers, however, cause optical loss in the connection with short wavelength region multimode optical fibers.

FIG. 1A is a refractive index profile of the “double clad fiber” disclosed in Patent Document 1 used for an amplifier, and FIG. 1B is a cross sectional diagram of the double clad fiber having the refractive index profile shown in FIG. 1A.

In FIG. 1B, a first cladding 21 is provided for simultaneously guiding output light from a pump laser to the outside of a core 11 through which an optical signal is guided, and a second cladding 31 formed of polymer resin is further provided on the outside thereof for cover. In FIG. 1A, reference numeral 12 denotes the refractive index of the core 11, reference numeral 22 denotes the refractive index of the first cladding 21, and reference numeral 32 denotes the refractive index of the second cladding 31.

When the “double clad fiber” is bent in a shape shown in FIG. 2 with one point as the center and with a curvature radius of R, the refractive index profile is raised toward the outer circumference (on the right side in FIG. 3) as shown in FIG. 3. In FIG. 2, reference numeral 71 denotes a curvature center, reference numeral 72 denotes the curvature radius, reference numeral 73 denotes the outer circumference side of the optical fiber in the case where the optical fiber is bent, and reference numeral 74 denotes the inner circumference side of the optical fiber in the case where the optical fiber is bent. In FIG. 3, reference numeral 75 denotes a maximum value of the refractive index of the core when the curvature radius is R.

At this time, a region (shaded region in FIG. 3) may be formed where the refractive index 22 of the first cladding 21 on the outer circumference side is higher than the maximum value 75 of the refractive index 12 of the core 11. Therefore, when a part of the signal light guided through the core 11 enters a radiation mode due to the bend and propagates to the first cladding 21, the part of the signal light couples with the shaded region described above to propagate in multimode. When the “double clad fiber” returns to the linear shape, the refractive index profile also returns to that of FIG. 1, whereby the part of the signal light propagating in multimode re-couples with the core 11 and optically interferes with the signal light guided through the core 11. This phenomenon is not preferable since it may cause an error during demodulation at the receiving end of the optical signal.

Optical fibers provided in buildings are applied to respective provided interfaces by being classified into short wavelength region single mode fibers and long wavelength region multimode fibers, and they are used in combination. In constructions for providing fibers which are required every time an instrument is newly provided or an instrument is moved, different optical fibers are necessary for the respective interfaces described above. In the long wavelength region single mode fibers, coarse wavelength division multiplexing (CWDM) technology has made it possible to avoid new provisions of optical fibers in a building by wavelength multiplexing at low cost. However, there is no optical fiber capable of transmitting the single mode and the multimode, as being a single fiber, by multiplexing the two modes. Accordingly, construction for providing fibers is generally necessary when an optical communication instrument including an optical interface having different propagation modes is installed or moved.

That is, in the “double clad fiber” disclosed in Patent Document 1, the first cladding 21 is designed to guide the output light from the pump laser, and the diameter of the first cladding 21 is made greater to perform amplification more efficiently, i.e., to input more of the output light from the pump laser to the first cladding 21. Thus, it has been difficult to connect the “double clad fiber” with a multimode optical fiber, which is introduced to the local area network (LAN) and has an optical signal wavelength of 850 nm, with small loss and to transmit multimode signal light with small loss.

In recent years, optical backplanes, in which boards arranged inside a device are optically connected, have been researched and developed in various research facilities, and some of them have been commercialized. However, transmission paths introduced thereto are generally short wavelength region multimode fibers. In consideration of extending the optical backplane which proactively utilizes the operation of light capable of long distance connection, it is preferable to introduce the single mode fiber to a part of the optical backplane described above. In this case, a preferable transmission path as the optical fiber introduced to the optical backplane is a light transmission path compliant with both of the short wavelength multimode transmission and the long wavelength single mode transmission.

The present invention has been made in view of the problem described above, and has an object of providing a double core optical fiber through which single mode signal light and multimode signal light can be transmitted, and in which multimode transmission of signal light guided through the core can be reduced even when the optical fiber is bent.

In order to achieve the object described above, a first aspect of the present invention provides a double core optical fiber having a first core and a second core, comprising a first material arranged on a central axis of the double core optical fiber and having a first refractive index, a second material arranged on an outer circumference of the first material and having a second refractive index smaller than the first refractive index, and a third material arranged on an outer circumference of the second material and having a third refractive index smaller than the second refractive index, wherein the first material is the first core, the first material and the second material are the second core, the second material is a first cladding for the first core, the third material is a second cladding for the second core, the double core optical fiber has a single mode characteristic, in which only a specified mode is performed as a propagation mode when only the first core is selectively excited using an optical signal in a first wavelength region, and a mode field diameter in the specified mode has a value equal to a mode field diameter of a single mode optical fiber capable of a single mode transmission in the first wavelength region, and a diameter of the second core has a value equal to a core diameter of a graded index multimode fiber or a step index multimode fiber used as a transmission path of an optical signal in a second wavelength region.

In the first aspect, a ratio d₂/d₁ between an outer diameter d₁ of the first material and a diameter d₂ of the second material may satisfy the relationship 4.5<d₂/d₁≦62.5/7.0.

In the first aspect, an outer diameter d₃ of the third material may satisfy the relationship 55 μm≦d₃≦125 μm.

In the first aspect, a fourth material, arranged on an outer circumference of the third material and having a fourth refractive index smaller than the third refractive index, may further be provided.

In the first aspect, the outer diameter d₃ of the third material may satisfy the relationship 55 μm≦d₃<125 μm.

In the first aspect, a polymer resin, arranged on an outer circumference of the fourth material and having a fifth refractive index greater than the fourth refractive index, for covering the double core optical fiber may be further provided.

In the first aspect, it may be such that the first material is quartz doped with at least one of elements Ge, P, Sn, and B, the second material is pure quartz, and the third material and the fourth material are quartzes respectively doped with different amounts of the element F or the element B.

In the first aspect, it may be such that a fourth material arranged on an outer circumference of the third material is further provided, and the fourth material is pure quartz or quartz in which pure quartz is doped with at least one of elements Ge, P, Sn, and B.

A second aspect provides a double core optical fiber having a first core and a second core, comprising a first material arranged on a central axis of the double core optical fiber and having a first refractive index, a second material arranged on an outer circumference of the first material and having a second refractive index smaller than the first refractive index, and a third material arranged on an outer circumference of the second material and having a third refractive index smaller than the second refractive index, wherein the second material has a first region and a second region of different sectional shapes, the first region being a region including a part of a surface of the second material and excluding the first material, the second region being a region of the second material other than the first region, the second region having the second refractive index, and the first region having a fourth refractive index smaller than the second refractive index and greater than the third refractive index, the first material is the first core, the first material and the second material are the second core, the second material is a first cladding for the first core, the third material is a second cladding for the second core, the double core optical fiber has a single mode characteristic, in which only a specified mode is performed as a propagation mode when only the first core is selectively excited using an optical signal in a first wavelength region, and a mode field diameter in the specified mode has a value equal to a mode field diameter of a single mode optical fiber capable of a single mode transmission in the first wavelength region, and a diameter of the second core has a value equal to a core diameter of a graded index multimode fiber or a step index multimode fiber used as a transmission path of an optical signal in a second wavelength region.

In the second aspect, a ratio d₂/d₁ between a diameter d₁ of the first material and a diameter d₂ of the second core including the first material and the second material may satisfy the relationship 4.5≦d₂/d₁≦62.5/7.0.

In the second aspect, an outer diameter d₃ of the third material may satisfy the relationship 55 μm≦d₃≦125 μm.

In the second aspect, a polymer resin, arranged on an outer circumference of the third material and having a fifth refractive index greater than the third refractive index, for covering the double core optical fiber may further be provided.

In the second aspect, any one of a structure having a rectangular U-shaped hollow structure which is bonded to a surface of the polymer resin or formed integrally with the polymer resin, and a structure having a curved surface which is in contact with the surface of the polymer resin may be provided, the structures both being located in a direction from a center of the double core optical fiber to a peak of a curved arc of a cross-sectional shape of the first region. In addition, when the double core optical fiber is bent along an arc having a certain center point, the structure controls a bend direction of the double core optical fiber such that the first region faces the outside away from the center point.

In the second aspect, it may be such that the first material is quartz doped with at least one of elements Ge, P, Sn, and B, the second region is pure quartz, and the first region and the third material are quartzes respectively doped with different amounts of the element F or the element B.

In the first or second aspect, it may be such that an optical signal transmitted in single mode by exciting the specified mode of the first core has a wavelength in a C-Band region (1530 nm to 1560 nm) or an L-Band region (1570 nm to 1610 nm), the mode field diameter in the specified mode is 8.0 μm to 10.0 μm, an optical signal transmitted in multimode by exciting the second core has a wavelength in an 850 nm region, and the diameter of the second core is 50 μm to 62.5 μm.

In the first or second aspect, it may be such that an optical signal transmitted in single mode by exciting the specified mode of the first core has a wavelength in a 1300 nm region, the mode field diameter in the specified mode is 8.0 μm to 10.0 μm, an optical signal transmitted in multimode by exciting the second core has a wavelength in an 850 nm region, and the diameter of the second core is 50 μm to 62.5 μm.

According to the present invention, the first material and the second and third materials provided on the outer circumference thereof enable one optical fiber to have two different aperture ratios of an aperture ratio of an optical fiber for single mode transmission in the first wavelength region (for example, long wavelength region) and an aperture ratio of optical fiber for multimode transmission in the second wavelength region (for example, short wavelength region) whereby optical signals in two different wavelength regions and different propagation modes can share one optical fiber. Further, by making the refractive index of the third material smaller than the refractive index of the second material, the multimode transmission of long wavelength region signal light being transmitted through the core can be reduced in a certain curvature radius R, whereby a stable single mode transmission is made possible.

### BRIEF DESCRIPTION OF THE DRAWINGS

FIG. 1A is a refractive index profile of a conventional double clad fiber;

FIG. 1B is a cross sectional diagram of a double clad fiber having the refractive index profile of FIG. 1A;

FIG. 2 is an illustrative diagram of when an optical fiber is bent with one point as the center and with a curvature radius of R;

FIG. 3 is a changed refractive index profile when the double clad fiber shown in FIGS. 1A and 1B is bent with the curvature radius of R;

FIG. 4A is a refractive index profile of a double core optical fiber according to a first embodiment of the present invention;

FIG. 4B is a cross sectional diagram of the double core optical fiber having the refractive index profile of FIG. 4A;

FIG. 5 is a changed refractive index profile when the double core optical fiber according to the first embodiment of the present invention is bent with the curvature radius of R;

FIG. 6A is a refractive index profile of a double core optical fiber according to a second embodiment of the present invention;

FIG. 6B is a cross sectional diagram of the double core optical fiber having the refractive index profile of FIG. 6A;

FIG. 7 is a changed refractive index profile when the double core optical fiber according to the second embodiment of the present invention is bent with the curvature radius of R; and

FIG. 8 is a diagram showing a transmission spectrum of the double core optical fibers according to the first and second embodiments of the present invention and a transmission spectrum of the conventional double clad fiber.

### BEST MODES FOR CARRYING OUT THE INVENTION

Embodiments of the present invention will be described below in detail with reference to the drawings. Note that portions having the same functions are denoted by the same reference numerals in the drawings described below, and redundant descriptions thereof are omitted.

One embodiment of the present invention provides an optical fiber, i.e., a double core optical fiber, in which single mode signal light and multimode signal light can be transmitted with the same optical fiber. Further, the optical fiber eliminates or reduces formation of a region having a higher effective refractive index than the core, even when the optical fiber is bent.

A conventional double clad fiber disclosed in Patent Document 1 includes a core 11 for single mode transmission and two claddings (first cladding 21 and second cladding 31). Output light from a pump laser is inputted to the first cladding 21, and the inputted light propagates in multimode through the core 11 and the first cladding 21. However, this light is light exclusively for amplification for the core 11, and is not the signal light. Thus, the signal light to be transmitted is only the single mode signal light transmitted through the core 11. Since the light for amplification propagates in multimode in the double clad fiber, the diameter of the first cladding 21 is designed to be greater. Since the signal light does not propagate the first cladding, alignment of center axes is not necessary, whereby a large diameter can be achieved for the cladding 21 in which a greater diameter is preferred.

In contrast, in one embodiment of the present invention, a core for single mode transmission and a core for multimode transmission are both provided in one optical fiber. The core for single mode transmission according to one embodiment of the present invention is a first material, which is at the innermost of the optical fiber and has a refractive index n₁, and has a single mode characteristic in which the propagation mode becomes only a specified mode when only the core is selectively excited using an optical signal in a long wavelength region. In addition, the mode field diameter in the specified mode is of the same value or approximately the same value as the mode field diameter of the single mode optical fiber capable of the single mode transmission in the long wavelength region described above. That is, the core for single mode transmission according to one embodiment of the present invention has an aperture ratio of a generally-used optical fiber for long wavelength region single mode transmission.

The core for multimode transmission according to one embodiment of the present invention is a core formed by a combination of the first material as the core for single mode transmission and a second material, which is formed to cover the first material and has a refractive index n₂ smaller than the refractive index n₁. The diameter of the core is of the same value or approximately the same value as the core diameter of a graded index multimode fiber or a step index multimode fiber used as the transmission path of an optical signal in a short wavelength region. That is, the core for multimode transmission according to one embodiment of the present invention has an aperture ratio of a generally-used optical fiber for short wavelength region multimode transmission. Thus, using the double core optical fiber according to one embodiment of the present invention enables small loss connections with the single mode optical fiber and the multimode optical fiber.

Note that the second material functions as a cladding for the core for single mode transmission, and functions as the core for multimode transmission described above together with the first material for the core for multimode transmission.

A third material is formed as a cladding for the core for multimode transmission so as to cover the core for multimode transmission. A refractive index n₃ of the third material is smaller than the refractive index n₂ of the second material. That is, the third material functions as a cladding for the core for multimode transmission formed of the first material and the second material described above, whereby a favorable multimode signal light transmission can be achieved.

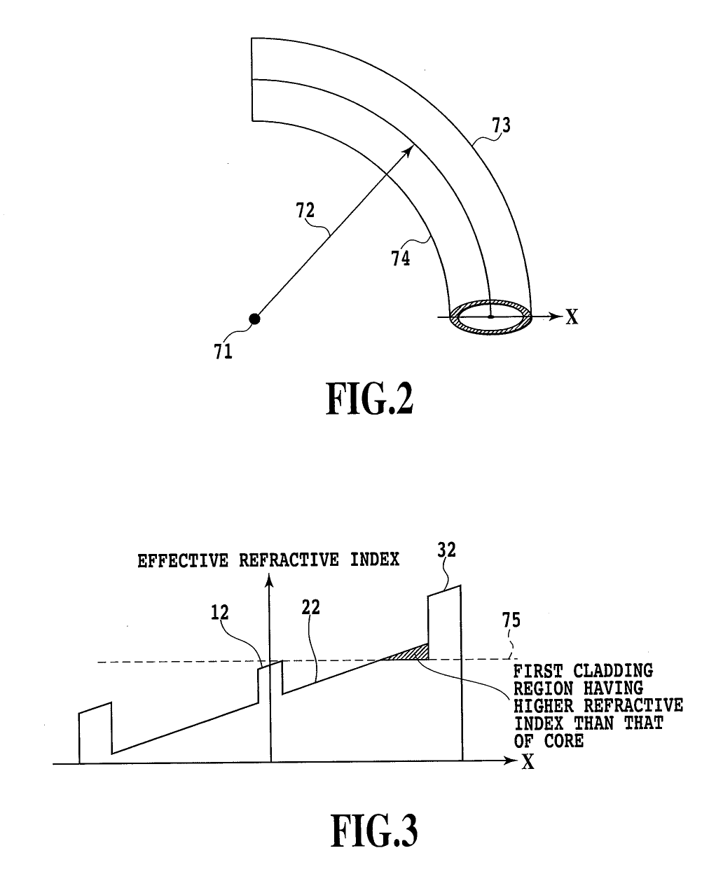

By providing the third material having a smaller refractive index than that of the second material in the circumference of the second material included in the core for multimode transmission, formation of a region having a higher refractive index than that of the first material guiding the single mode signal light on the outer circumference side can be reduced even if the double core fiber is bent as shown in FIG. 2. That is, since the third material having a lower refractive index than that of the second material is provided in a region including at least a shaded region shown in FIG. 3 or in a part of the shaded region described above, the shaded region can be eliminated or reduced. Thus, the multimode transmission of the signal light guided through the first material can be reduced.

Further, by providing the third material having a smaller refractive index than that of the second material, leakage of the light from the second material to the third material can be suppressed. The effect of suppressing leakage is further emphasized by providing a fourth material, which has a refractive index n₄ smaller than the refractive index n₃ of the third material, in the circumference of the third material. Thus, the fourth material being formed to cover the third material is a further preferable form.

Note that, although the refractive index of the fourth material is preferably smaller than the refractive index of the third material, the effect of suppressing leakage described above can be increased even if the refractive index of the fourth material is higher than the refractive index of the third material.

In one embodiment of the present invention, the refractive index of a region of the second material, which includes a portion of an outer circumference portion (surface portion of the second material) and does not include the first material, may be made smaller than the refractive index n₂. Note that, in this case, a hollow structure having a rectangular U-shaped cross section as means for controlling the bend direction is formed by being bonded to, or integrated with, the surface of the optical fiber (for example, the surface of the polymer resin for cover). With such configuration, the optical fiber bends in a direction 180 degrees (to an opposing side) from the side on which the means described above is formed. The refractive index of the second material on the outer circumference side at the bend becomes smaller than the refractive index n₂ of the second material, whereby the effect described above can be obtained. Note that, in one embodiment of the present invention, the means for controlling the bend direction is not limited to the hollow structure described above, and may be a structure having a curved surface to contact the surface described above, as long as the direction of the bend can be determined uniquely. When using such structure, it suffices that the curved surface described above be brought into contact with the surface described above. The structure having the curved surface described above may be hollow or may not be hollow inside.

Note that, in one embodiment of the present invention,

it is not essential that the signal light in long wavelength region is propagated as the single mode signal light, and that the signal light in short wavelength region is propagated as the multimode signal light. What is important is that the single mode signal light and the multimode signal light can be transmitted with the same optical fiber, and the signal light to be propagated as the single mode signal light and the multimode signal light may have any wavelength. Thus, the single mode signal light may be the signal light in short wavelength region, and the multimode signal light may be the signal light in long wavelength region.

Thus, it suffices that the core for single mode transmission have an aperture ratio of an optical fiber for single mode transmission, and the core for multimode transmission have an aperture ratio of an optical fiber for multimode transmission.

Note that, in one embodiment of the present invention, the first to fourth materials may be, for example, glass materials or organic materials such as polymers and acrylics, as long as the materials have the aforementioned relations regarding the refractive indices, and function as the core or cladding of the optical fiber.

### First Embodiment

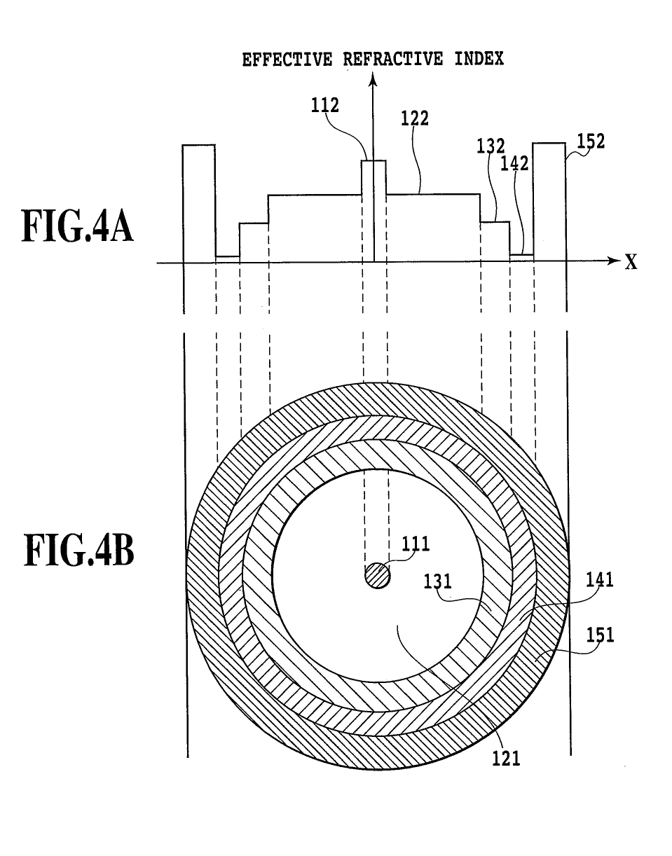

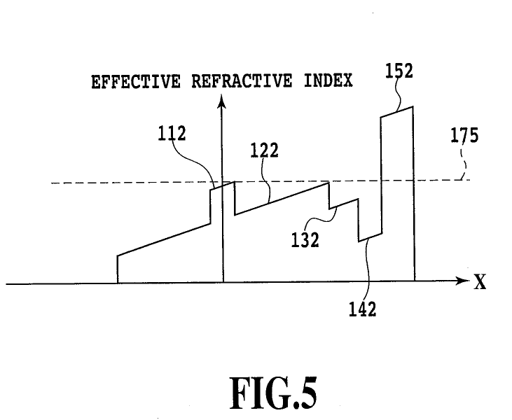

FIG. 4A is a refractive index profile of a double core fiber according to this embodiment, and FIG. 4B is a cross sectional diagram of the double core optical fiber having the refractive index profile of FIG. 4A.

In FIG. 4B, a core 111 as the first material for single mode transmission is provided at the center, and a first cladding 121 as the second material, a second cladding 131 as the third material, a third cladding 141 as the fourth material, and a fourth cladding 151 constituted of a polymer resin are sequentially provided on the outside of the core 111. Note that, as the core 111 and the first to third claddings, materials generally used for optical fibers, e.g., quartz glass and organic matters such as polymer and acrylic, may be used.

In this embodiment, the core 111 is formed of quartz doped with at least one of elements Ge, P, Sn, and B. The first cladding 121 is formed of pure quartz. Further, the second cladding 131 and the third cladding 141 are formed of quartzes respectively doped with different amounts of the element F to reduce the refractive indices.

Note that, in this embodiment, the dopant (for example, elements Ge, P, Sn, and B) for doping the core 111 is selected so as to increase the refractive index of the primary material such as quartz.

In this embodiment, the quartz for the second cladding 131 and the third cladding 141 is doped with the element F, but another dopant may be used. For example, as the dopant for doping the primary material of the second cladding 131 and the third cladding 141 such as quartz, any dopant which can reduce the refractive index of the quartz, such as the element B, may be used. In this embodiment, by doping the third cladding 141 with the element B in addition to the element F, the refractive index can further be reduced.

In FIG. 4A, reference numeral 112 denotes the refractive index of the core 111, reference numeral 122 denotes the refractive index of the first cladding 121, reference numeral 132 denotes the refractive index of the second cladding 131, reference numeral 142 denotes the refractive index of the third cladding 141, and reference numeral 152 denotes the refractive index of the fourth cladding 151. As can be seen from FIG. 4A, the refractive index 122 of the first cladding 121 is smaller than the refractive index 112 of the core 111, the refractive index 132 of the second cladding 131 is smaller than the refractive index 122 of the first cladding 121, and the refractive index 142 of the third cladding 141 is smaller than the refractive index 132 of the second cladding 131. The refractive index 152 of the fourth cladding 151 is higher than the refractive index 142 of the third cladding 141.

In this embodiment, the relative refractive index difference of the core 111 and the first cladding 121 is preferably 0.1 to 0.5%. By setting the relative refractive index difference of the core 111 and the first cladding 121 in this manner, the single mode signal light can be transmitted favorably through the core 111, which is the core for single mode transmission.

The relative refractive index difference of the first cladding 121 and the second cladding 131 is preferably 0.3 to 0.9%. By setting the relative refractive index difference of the first cladding 121 and the second cladding 131 in this manner, the multimode signal light can be transmitted favorably through the core 111 and the first cladding 121 which are the core for multimode transmission.

Further, the relative refractive index difference of the second cladding 121 and the third cladding 141 is preferably 0.1 to 0.3%.

In such configuration, the core 111 functions as the core for single mode transmission, and the core 111 and the first cladding 121 function as the core for multimode transmission.

Note that, in this embodiment, the wavelength of the optical signal for single mode transmission (wavelength of the optical signal transmitted in single mode by exciting the specified mode of the core 111) can be designed to be in any one of the C-Band region (1530 nm to 1560 nm), the L-Band region (1570 nm to 1610 nm), and the 1300 nm region. The mode field diameter may be 7.0 to 10.0 μm. That is, the mode field diameter in the specified mode described above may be 7.0 to 10.0 μm.

In this embodiment, with multimode signal light having a wavelength of 850 nm, a field intensity distribution is formed all over the core 111, the first cladding 121, and the second cladding 131, and the aperture ratio is designed to be equivalent to that of an 850 nm wavelength region step index multimode fiber or an 850 nm wavelength region graded index multimode fiber. The wavelength of the optical signal for multimode transmission (wavelength of the optical signal transmitted in multimode by exciting the core for multimode transmission formed of the core 111 and the first cladding 121) is designed to be in the 850 nm region. Further, the diameter of the core for multimode transmission, i.e., the outer diameter of the first cladding 121, may be 50 μm or 62.5 μm. Note that, in this embodiment, the essence is not that the diameter of the core for multimode transmission is 50 μm or 62.5 μm. In this embodiment, the essence is that the single mode signal light and the multimode signal light can be transmitted with one optical fiber, and the diameter of the core for multimode transmission may be of any value as long as the multimode signal light can be transmitted. In this embodiment, the diameter of the core for multimode transmission may be greater than 31.5 and less than or equal to 62.5 μm.

As described above, since the preferable mode field diameter is 7.0 to 10.0 μm, the preferable diameter of the core 111 is 7.0 to 10.0 μm. Also, as described above, the preferable diameter of the core for multimode transmission, i.e., the outer diameter of the first cladding 121, is greater than 31.5 μm and less than or equal to 62.5 μm.

As can be seen from the description above, one object of the present invention is to enable transmission of the single mode signal light and the multimode signal light with the same fiber. In order to achieve the object, it is important in the present invention to set the diameter of the core for single mode transmission (diameter of the core 111) to a diameter which transmits the single mode signal light favorably, and set the diameter of the core for multimode transmission (diameter of the first cladding 121) to a diameter which transmits the multimode signal light favorably. In consideration of this requirement, a ratio d₂/d₁ which is a ratio between a diameter d₁ of the core 111, which is the diameter of the core for single mode transmission, and an outer diameter d₂ of the first cladding 121, which is the diameter of the core for multimode transmission, is as follows.

The maximum value of the ratio d₂/d₁ satisfying the requirement described above is obtained when the core 111 which is the core for single mode transmission is minimum (d₁=7.0 μm), and the outer diameter d₂ of the first cladding 121 which is the core for multimode transmission is maximum (d₂=62.5 μm). Thus, the ratio d₂/d₁ is less than or equal to 62.5/7.

Next, it can be considered that the minimum value of the ratio d₂/d₁ satisfying the requirement described above is obtained when the core 111 which is the core for single mode transmission is maximum (d₁=10.0 μm), and the outer diameter d₂ of the first cladding 121 which is the core for multimode transmission is minimum (d₂=31.5 μm). However, when the optical fiber in this case is used as the transmission path and connected to a generally-used optical fiber for multimode (for example, a commercially-available optical fiber for multimode having an outer diameter of 50 μm), the connection loss is large. The connection loss becomes greater than or equal to 10 dB when the ratio d₂/d₁ is less than or equal to 4.5. When the connection loss with the optical fiber for multimode having an outer diameter of 50 μm becomes greater than or equal to 10 dB in this manner, using it as the transmission path becomes difficult.

On the other hand, the connection loss described above can be suppressed to less than or equal to 10 dB when the ratio d₂/d₁ becomes greater than 4.5. That is, when the diameter of the core 111 is 7.0 μm, the outer diameter of the first cladding 121 has a slightly larger value than 31.5 μm, and a multimode optical fiber having an outer diameter of 50 μm is connected, the outer diameter of the first cladding 121 differs from 50 μm, thereby causing the connection loss. However, in this case, since the ratio d₂/d₁ is greater than 4.5, the connection loss is less than or equal to 10 dB, whereby it can well be used as the fiber for multimode transmission. Thus, in this embodiment, the ratio d₂/d₁ takes a greater value than 4.5.

Note that, even if the value of the ratio d₂/d₁ is close to 4.5, the connection loss described above can obviously be made smaller as the outer diameter of the first cladding 121 approaches 50 μm.

In this manner, in this embodiment, the ratio d₂/d₁ preferably satisfies 4.5<d₂/d₁≦62.5/7.0.

Note that, in this embodiment, an outer diameter d₃ of the second cladding is preferably 5 μm≦d₃≦125 μm, and more preferably 55 μm≦d₃<125 μm, while taking a greater value than the outer diameter d₂.

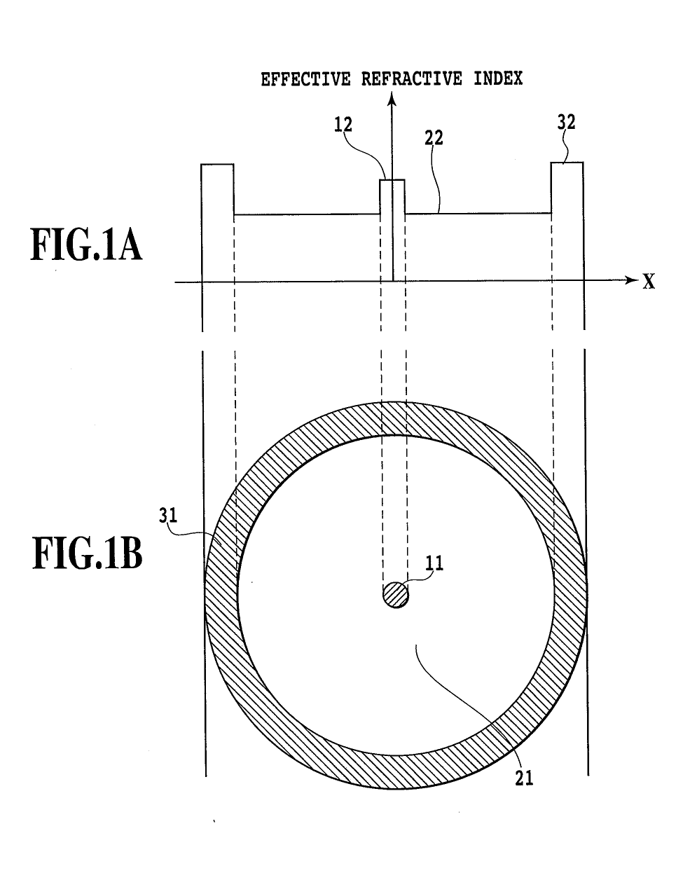

In the conventional double clad fiber shown in FIG. 1, in addition to the signal light guided through the core 11, the output light from the pump laser for amplifying the signal light is guided, as described above. The output light is transmitted in multimode through the double clad fiber, but is not signal light. In order to amplify the signal light described above more efficiently, the output light needs to be inputted from the pump laser as much as possible. Therefore, the diameter of the first cladding 21 is designed to be as large as possible. That is, in the conventional double clad fiber, the light inputted to the first cladding 21 is not the multimode signal light whereby axis alignment is not necessary. In addition, the diameter of the first cladding 21 is designed to be as large as possible, and the aperture ratio is not set to be the same as that of optical fiber for multimode transmission. Thus, with the conventional double clad fiber, it is difficult to connect the optical fiber for multimode transmission (for example, multimode optical fiber having an optical signal wavelength of 850 nm, which is introduced to LAN) with small loss, and to transmit the multimode signal light with small loss.

In contrast, in this embodiment, the diameter of the first cladding 121 which specifies the diameter of the core for multimode transmission is set to be the same or approximately the same as the diameter of the optical fiber for multimode transmission, so that the aperture ratio of the optical fiber for multimode transmission is obtained. Thus, the optical fiber for multimode transmission described above can connect with small loss and transmit the multimode signal light with small loss.

Further, in this embodiment, since the core 111 included in the core for multimode transmission also functions as the core for single mode transmission, it can connect with an optical fiber for single mode with small loss and transmit the single mode signal light with small loss.

That is, the single mode signal light and the multimode signal light can both or individually be transmitted with the same optical fiber.

FIG. 5 shows a refractive index profile when the double core fiber of this embodiment is bent in the shape shown in FIG. 2. Note that, in FIG. 5, reference numeral 175 denotes the maximum value of the refractive index of the core 111 when the curvature radius is R.

At this time, the refractive index on the outer circumference side of the second cladding 121 (right side in FIG. 5) increases. However, the refractive index 132 of the second cladding 131 is set to be smaller than the refractive index 122 of the first cladding 121, and the refractive index 142 of the third cladding 141 is further set to be smaller than the refractive index 132. Thus, even with the curvature radius by which the region having a refractive index higher than the refractive index of the core is formed in the conventional double clad fiber, the formation of the region having a refractive index higher than the refractive index 112 of the core 111 can be eliminated. Thus, the phenomenon seen in the “double clad fiber” mentioned earlier does not occur, the transmission characteristic of the optical signal transmitted through the core is not degraded, and errors during demodulation at the receiving end of the optical signal does not increase. That is, when the optical fiber is bent, the single mode signal light reach and be absorbed by the fourth cladding 151 while a part of the single mode signal light leaked from the core 111 is not trapped in the first cladding 121, the second cladding 131, and the third cladding 141, or is not reflected therefrom to return to the core 111. Thus, a stable simultaneous single mode transmission and multimode transmission while the optical fiber is bent are achieved.

By reducing the curvature radius R (forming a more acute bend), a region in which the refractive index 132 or 142 is greater than the maximum value 175 may be formed. Even if such region having a value higher than the maximum value 175 is formed, that region is smaller than the region described above formed in the conventional double clad fiber when bent with the same curvature radius of R. Thus, the multimode transmission, which is due to the radiation mode caused by the bend described above, of the single-mode-signal light guided through the core 111 in the case where the optical fiber is bent can be reduced.

In this embodiment, with the curvature radius R by which the region having a higher refractive index than that of the core is formed in the conventional double clad fiber, the region described above can be eliminated or the region can be reduced in this manner compared to a conventional case even if the region described above is formed, whereby the multimode transmission of the signal light guided through the core can be reduced.

In the conventional double clad fiber, the diameter of the first cladding 21 needs to be large in order to input more output light from the pump laser as described above. In consideration of such object, providing the second cladding 131 and the third cladding 141 according to this embodiment has not been an option in the conventional double clad fiber. On the other hand, in this embodiment, the second cladding 131 having the refractive index 132 lower than the refractive index 122 has a function of further trapping the multimode signal light in the core for multimode transmission, and further has a function of reducing the multimode transmission of the single mode signal light guided through the core 111 when the optical fiber is bent.

The third cladding 141 having the refractive index 142 lower than the refractive index 132 has a function of further favorably trapping the multimode signal light in the core for multimode transmission. That is, the third cladding 141 doped with the element F to have a low refractive index serves to reduce the multimode signal light guided to the fourth cladding 151 which is the cover formed of polymer resin.

In this embodiment, the quartz subjected to a process of doping with the element F to reduce the refractive index is used for the third cladding 141, but it is not limited thereto. For example, as the material of the third cladding 141, pure quartz may be used. Also, for the third cladding 141, a material in which the primary material such as pure quartz is doped with at least one of the elements Ge, P, Sn, and B may be used. As described above, the refractive index of the third cladding 141 is preferably smaller than the refractive index of the second cladding 131, but leakage of light from the first cladding 121 to the second cladding 131 can be further suppressed even if the refractive index of the third cladding 141 is higher than the refractive index of the second cladding 131.

Note that, in this embodiment, as described above, the effect of suppressing leakage of light described above can sufficiently be obtained even if the refractive index of the third cladding 141 is not smaller than the refractive index of the second cladding 131, i.e., even if quartz is used for the third cladding 141. Thus, by using quartz for the third cladding 141, doping with the dopant (element F, B, or the like) for controlling the refractive index is unnecessary, whereby the manufacturing cost can be lowered.

The element F and the element B are said to be vulnerable to humidity, but quartz is a material highly resistant to humidity. Therefore, by using pure quartz which is not doped with the element F and the element B for the third cladding 141, the humidity resistance can be improved. Thus, it can be used in more variable environments.

### Second Embodiment

In this embodiment, the direction of the bend of the optical fiber is determined in advance, and the refractive index is made low in a region on the outer circumference side of the optical fiber when bent in the determined direction, which includes a part of the outer circumference portion (surface portion) of the material (second material) formed to cover the core for single mode signal light and excludes the core.

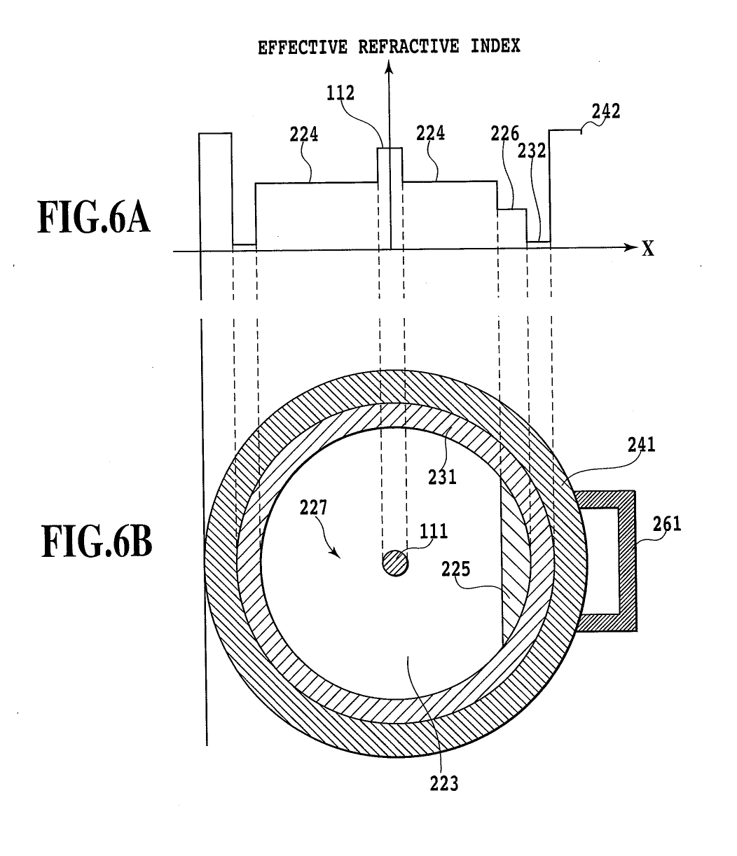

FIG. 6A is a refractive index profile of the double core fiber according to this embodiment, and FIG. 6B is a cross sectional diagram of the double core optical fiber having the refractive index profile of FIG. 6A.

In FIG. 6B, the core 111 as the first material for single mode transmission is provided in the center, and a first cladding 227 as the second material, a second cladding 231 as the third material, and a third cladding 241 constituted of polymer resin are sequentially provided on the outside of the core 111. Note that, as the core 111 and the first and second claddings, materials generally used for optical fibers, e.g., quartz glass and organic matters such as polymer and acrylic, may be used.

In this embodiment, the core 111 is formed of quartz doped with one of the elements Ge, P, Sn, and B. The first cladding 227 is formed of pure quartz. Further, the second cladding 231 is formed of quartz doped with the element F.

Note that, in this embodiment, as shown in FIG. 6B, the first cladding 227 is divided into a region 223 encompassing the core 111 and a region 225 not encompassing the core 111. That is, the first cladding 227 has two regions (region 223 and region 225) having different sectional shapes. The region 225 is a region including a portion of the outer circumference portion (surface portion) of the first cladding 227, and, as described later, has a refractive index smaller than the refractive index of the region 223. That is, the region 225 is doped with the element F in a different amount from the element F with which the second cladding 231 is doped, whereby the refractive index is set lower than that of the region 223.

In FIG. 6A, the reference numeral 112 denotes the refractive index of the core 111, reference numeral 224 denotes the refractive index of the region 223 of the first cladding 227, reference numeral 226 denotes the refractive index of the region 225 of the first cladding 227, reference numeral 232 denotes the refractive index of the second cladding 231, and reference numeral 242 denotes the refractive index of the third cladding 241. As can be seen from FIG. 6A, the refractive index 224 of the region 223 is smaller than the refractive index 112 of the core 111, the refractive index 226 of the region 225 is smaller than the refractive index 224 of the region 223, and the refractive index 232 of the second cladding 231 is smaller than the refractive index 226 of the region 225. The refractive index 242 of the third cladding 241 is higher than the refractive index 232 of the second cladding 231.

In this embodiment, the relative refractive index difference of the core 111 and the region 223 of the first cladding 227 is preferably 0.1 to 0.5%. By setting the relative refractive index difference of the core 111 and the region 223 in this manner, the single mode signal light can favorably be transmitted through the core 111 which is the core for single mode transmission.

The relative refractive index difference of the region 223 and the region 225 of the first cladding 227 is preferably 0.2 to 0.3%.

The relative refractive index difference of the region 223 and the second cladding 231 is preferably 0.3 to 0.9%. By setting the relative refractive index difference of the first cladding 227 and the second cladding 231 in this manner, the multimode signal light can favorably be transmitted through the core 111 and the first cladding 227, which are the core for multimode transmission.

In this embodiment, with a multimode signal light having a wavelength of 850 nm, a field intensity distribution is formed all over the core 111 and the region 223 of the first cladding 227, and the aperture ratio is designed to be equivalent to that of an 850 nm wavelength region step index multimode fiber or an 850 nm wavelength region graded index multimode fiber. The wavelength of the optical signal for multimode transmission (wavelength of the optical signal transmitted in multimode by exciting the core for multimode transmission formed of the core 111 and the first cladding 227) is designed to be in the 850 nm region. Further, the diameter of the core for multimode transmission, i.e., the diameter of the first cladding 227 may be 50 μm or 62.5 μm.

The third cladding 241 formed of polymer resin is arranged with a hollow structure 261, having a rectangular U-shaped cross section, located on a line connecting the center point of the double core optical fiber and the center point of the region 225. By bending the double core optical fiber of this embodiment such that the hollow structure 261 is in the outermost circumference position, the compression stress on the two legs in the rectangular U-shaped cross section of the hollow structure 261 contacting the third cladding 241 becomes lowest, whereby the bend direction is controlled. The hollow structure 261 described above determines the bend direction of the double core optical fiber to be a direction 180 degrees from the side of the optical fiber on which the hollow structure 261 is formed. That is, the hollow structure 261 controls the bend of the optical fiber such that the peak of the curved arc of a cross section of the region 223 is located at the curvature center (center of the bend) and that the peak of the curved arc of the cross section of the region 223 is located at a direction 180 degrees from the curvature center described above.

In this embodiment, the hollow structure 261 is used as means for controlling the bend direction, but it may be a structure without a hollow section (having the same material as or a different material from that of the structure in the hollow section). That is, a structure having a curved surface contacting the surface of the third cladding 241 may be used.

In this embodiment, the second cladding 231 doped with the element F to have a low refractive index serves to reduce the multimode signal light guided to the third cladding 241 which is the cover formed of polymer resin.

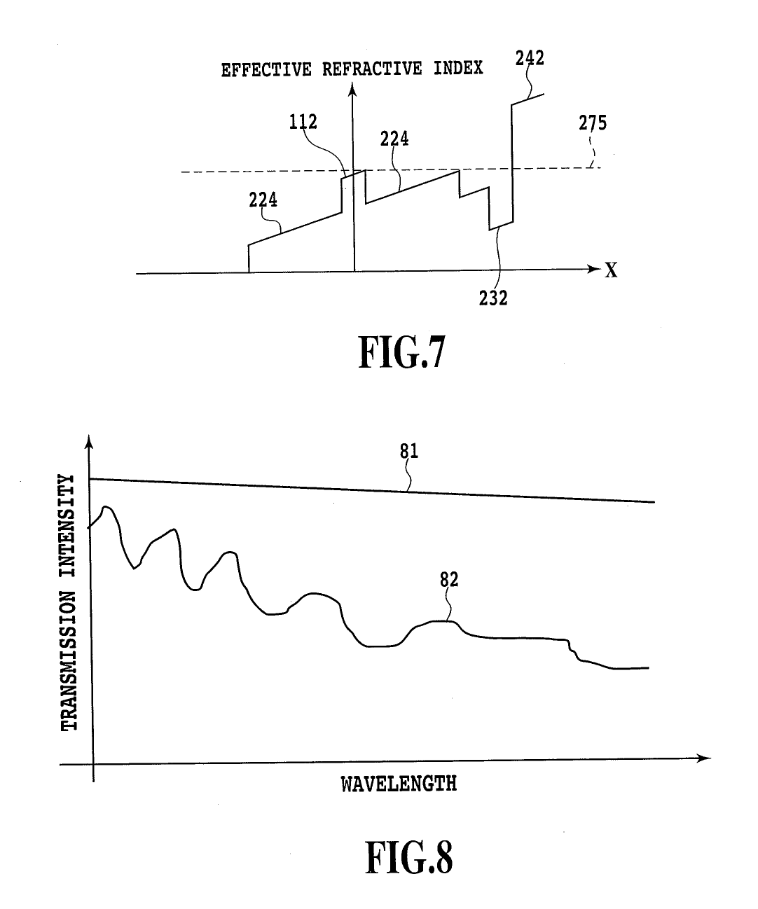

FIG. 7 shows a refractive index profile of the double core fiber of this embodiment when bent in the shape shown in FIG. 2. Note that, in FIG. 7, reference numeral 275 denotes the maximum value of the refractive index of the core 111 when the curvature radius is R.

At this time, the refractive index on the outer circumference side of the second cladding 227 (right side in FIG. 7) increases. However, the refractive index 226 of the region 225 is set to be smaller than the refractive index 224 of the region 223, and the refractive index 232 of the second cladding 231 is further set to be smaller than the refractive index 226. Therefore, even with the curvature radius by which the region having a refractive index higher than the refractive index of the core is formed in the conventional double clad fiber, the formation of the region having a refractive index higher than the refractive index 112 of the core 111 can be eliminated. Thus, in a similar manner as in the first embodiment, the phenomenon seen in the “double clad fiber” mentioned earlier does not occur, the transmission characteristic of the optical signal transmitted through the core is not degraded, and errors during demodulation at the receiving end of the optical signal does not increase. Thus, a stable simultaneous single mode transmission and multimode transmission when the optical fiber is bent are achieved.

By reducing the curvature radius R (forming a more acute bend), a region in which the refractive index 226 or 232 is greater than the maximum value 275 may be formed. In a similar manner to the first embodiment, even in such cases where the region having a refractive index higher than the maximum value 275 is formed, that region is smaller than the region described above formed in the conventional double clad fiber when bent with the same curvature radius of R. Thus, the multimode transmission, which is due to the radiation mode caused by the bend described above, of the single mode signal light guided through the core 111 in the case where the optical fiber is bent can be reduced.

In this embodiment, with the curvature radius R by which the region having a higher refractive index than that of the core is formed in the conventional double clad fiber, the region described above can be eliminated or the region can be reduced in this manner compared to a conventional case even if the region described above is formed, whereby the multimode transmission of the signal light guided through the core can be reduced.

FIG. 8 shows transmission spectrums of the conventional “double clad fiber” and the double core optical fibers of the first and second embodiments of the present invention when respectively bent at a constant curvature radius. A spectrum 82 of the “double clad fiber” has a beating fluctuation spectrum characteristic, but such phenomenon does not occur in a spectrum 81 of the double core optical fibers of the first and second embodiments of the present invention.

When the “double clad fiber” is bent with the constant curvature radius, the refractive index of the first cladding as the second material in the outer circumference side becomes higher than the refractive index of the core as the first material, whereby a part of the signal light propagating through the core propagates in multimode. Since optical fibers are provided with alternate bends and linear states, the optical signal propagated in multimode due to the bend of the “double clad fiber” easily re-couples with the core in the linear portion of the “double clad fiber.” Accordingly, it interferes with the optical signal which has been originally propagating through the core, leading to an increase in bit error. Further, the phenomenon described above has a wavelength dependency, whereby application as a wavelength division multiplexing (WDM) transmission path is difficult. On the other hand, the double core optical fiber according to one embodiment of the present invention has an approximately flat spectrum characteristic as shown in FIG. 8, and therefore is suitable for the WDM transmission path.

1. A double core optical fiber having a first core and a second core, comprising:
a first material arranged on a central axis of the double core optical fiber and having a first refractive index;
a second material arranged on an outer circumference of the first material and having a second refractive index smaller than the first refractive index; and
a third material arranged on an outer circumference of the second material and having a third refractive index smaller than the second refractive index; wherein
the first material is the first core;
the first material and the second material are the second core;
the second material is a first cladding for the first core;
the third material is a second cladding for the second core;
the double core optical fiber has a single mode characteristic in which only a specified mode is performed as a propagation mode when only the first core is selectively excited using an optical signal in a first wavelength region, and a mode field diameter in the specified mode has a value equal to a mode field diameter of a single mode optical fiber capable of a single mode transmission in the first wavelength region; and
a diameter of the second core has a value equal to a core diameter of any of a graded index multimode fiber and a step index multimode fiber used as a transmission path of an optical signal in a second wavelength region.

2. The double core optical fiber according to claim 1, wherein a ratio d2/d1 between a diameter d1 of the first material and an outer diameter d2 of the second material satisfies 4.5<d₂/d₁≦62.5/7.0.

3. The double core optical fiber according to claim 1, wherein an outer diameter d₃ of the third material satisfies 55 μm≦d₃≦125 μm.

4. The double core optical fiber according to claim 1, further comprising a fourth material arranged on an outer circumference of the third material and having a fourth refractive index smaller than the third refractive index.

5. The double core optical fiber according to claim 4, wherein the outer diameter d3 of the third material satisfies 55 μm≦d₃<125 μm.

6. The double core optical fiber according to claim 4, further comprising a polymer resin, arranged on an outer circumference of the fourth material and having a fifth refractive index greater than the fourth refractive index, for covering the double core optical fiber.

7. The double core optical fiber according to claim 4, wherein
the first material is quartz doped with at least one of elements Ge, P, Sn, and B;
the second material is pure quartz; and
the third material and the fourth material are quartzes respectively doped with different amounts of the element F or the element B.

8. The double core optical fiber according to claim 1, further comprising a fourth material arranged on an outer circumference of the third material, wherein
the fourth material is any of pure quartz and quartz in which pure quartz is doped with at least one of elements Ge, P, Sn, and B.

9. A double core optical fiber having a first core and a second core, comprising:
a first material arranged on a central axis of the double core optical fiber and having a first refractive index;
a second material arranged on an outer circumference of the first material and having a second refractive index smaller than the first refractive index; and
a third material arranged on an outer circumference of the second material and having a third refractive index smaller than the second refractive index; wherein
the second material has a first region and a second region of different sectional shapes, the first region being a region including a part of a surface of the second material but excluding the first material, the second region being a region of the second material other than the first region, the second region having the second refractive index, and the first region having a fourth refractive index smaller than the second refractive index and greater than the third refractive index;
the first material is the first core;
the first material and the second material are the second core;
the second material is a first cladding for the first core;
the third material is a second cladding for the second core;
the double core optical fiber has a single mode characteristic in which only a specified mode is performed as a propagation mode when only the first core is selectively excited using an optical signal in a first wavelength region, and a mode field diameter in the specified mode has a value equal to a mode field diameter of a single mode optical fiber capable of a single mode transmission in the first wavelength region; and
a diameter of the second core has a value equal to a core diameter of any of a graded index multimode fiber and a step index multimode fiber used as a transmission path of an optical signal in a second wavelength region.

10. The double core optical fiber according to claim 9, wherein
a ratio d₂/d₁ between a diameter d1 of the first material and a diameter d₂ of the second core including the first material and the second material satisfies 4.5<d₂/d₁≦62.5/7.0.

11. The double core optical fiber according to claim 9, wherein an outer diameter d₃ of the third material satisfies 55 μm≦d₃≦125 μm.

12. The double core optical fiber according to claim 9, further comprising a polymer resin, arranged on an outer circumference of the third material and having a fifth refractive index greater than the third refractive index, for covering the double core optical fiber.

13. The double core optical fiber according to claim 12, further comprising any one of a structure having a rectangular U-shaped hollow structure which is bonded to a surface of the polymer resin or formed integrally with the polymer resin, and a structure having a curved surface which is in contact with the surface of the polymer resin, the structures both being located in a direction from a center of the double core optical fiber to a peak of a curved arc of a cross-sectional shape of the first region, wherein
when the double core optical fiber is bent along an arc having a certain center point, the structure controls a bend direction of the double core optical fiber such that the first region faces the outside away from the center point.

14. The double core optical fiber according to claim 9, wherein
the first material is quartz doped with at least one of elements Ge, P, Sn, and B;
the second region is pure quartz; and
the first region and the third material are quartzes respectively doped with different amounts of the element F or the element B.

15. The double core optical fiber according to claim 1, wherein
an optical signal transmitted in single mode by exciting the specified mode of the first core has a wavelength in a C-Band region (1530 nm to 1560 nm) or an L-Band region (1570 nm to 1610 nm), and the mode field diameter in the specified mode is 8.0 μm to 10.0 μm; and
an optical signal transmitted in multimode by exciting the second core has a wavelength in an 850 nm region, and the diameter of the second core is 50 μm to 62.5 μm.

16. The double core optical fiber according to claim 1, wherein
an optical signal transmitted in single mode by exciting the specified mode of the first core has a wavelength in a 1300 nm region, and the mode field diameter in the specified mode is 8.0 μm to 10.0 μm; and
an optical signal transmitted in multimode by exciting the second core has a wavelength in an 850 nm region, and the diameter of the second core is 50 μm to 62.5 μm.

17. The double core optical fiber according to claim 9, wherein
an optical signal transmitted in single mode by exciting the specified mode of the first core has a wavelength in a C-Band region (1530 nm to 1560 nm) or an L-Band region (1570 nm to 1610 nm), and the mode field diameter in the specified mode is 8.0 μm to 10.0 μm; and
an optical signal transmitted in multimode by exciting the second core has a wavelength in an 850 nm region, and the diameter of the second core is 50 μm to 62.5 μm.

18. The double core optical fiber according to claim 9, wherein
an optical signal transmitted in single mode by exciting the specified mode of the first core has a wavelength in a 1300 nm region, and the mode field diameter in the specified mode is 8.0 μm to 10.0 μm; and
an optical signal transmitted in multimode by exciting the second core has a wavelength in an 850 nm region, and the diameter of the second core is 50 μm to 62.5 μm.
